(19) United States
(12) Patent Application Publication
(10) Pub. No.: US 2006/0158078 A1
(43) Pub. Date: Jul. 20, 2006

(54) Hid lamp assembly and a method for fixing an hid lamp in a reflector

(75) Inventors: Petrus Johannes Antonius Linssen, Eindhoven (NL); Ralph Hubert Peters, Eindhoven (NL); Wouter Petrus Kaandorp, Eindhoven (NL); Nicasius Gerardus Tielemanus Van Gennip, Heeze (NL); Benno Spinger, Aachen (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/543,281

(22) PCT Filed: Jan. 14, 2004
(86) PCT No.: PCT/IB04/50019

§ 371 Date: Jul. 25, 2005

(30) Foreign Application Priority Data
Jan. 28, 2003 (EP) 03100159.7

(51) Int. Cl. H01J 5/16

(52) U.S. Cl. 313/113

(57) ABSTRACT

An HID lamp assembly comprising a reflector (1), a discharge lamp (6), and a power control unit (2). The cap (8) of the lamp (6) extends through a hole (4) in the reflector. The power control unit (2) is attached to the rear of the reflector (1) near said hole (4). The power control unit (2) is provided with fixation means for keeping the lamp (6) in a predetermined position. The power control unit (2) is provided with a hole (5) coaxial with the hole (4) in the reflector, and the cap (8) of the lamp (6) extends through at least a portion of said hole (5) in the power control unit.

The invention relates to an HID (high intensity discharge) lamp assembly comprising a reflector, a discharge lamp, and a power control unit, wherein the cap of the lamp extends through a hole in the reflector and wherein the power control unit is attached to the rear of the reflector near said hole.

The power control unit in such a lamp assembly controls the delivery of power to the lamp and the operation of the lamp. It may comprise a starter circuit, a driver circuit, and a microprocessor or equivalent monitor and other control circuits.

U.S. Pat. No. 6313570 describes an HID lamp assembly wherein the power control unit is attached to the rear of the reflector. The discharge lamp thus extends through a hole in the reflector and is fixed to the reflector by fixation means attached to the reflector. The power control unit surrounds the cap of the discharge lamp at least partially, so that a compact lamp assembly is achieved. However, the fixation of the lamp can be improved.

The object of the invention is to provide a compact HID lamp assembly comprising an improved fixation of the lamp.

In order to accomplish that objective, the power control unit is provided with fixation means for keeping the lamp in a predetermined position. An accurate positioning of the lamp relative to the reflector is important for obtaining an optimal reflection of the light radiated by the lamp. Therefore, it is usual to provide the reflector with appropriate fixation means. However, since the power control unit is located at the rear of the reflector near the hole through which the cap of the lamp extends, the power control unit can be advantageously used for fixing the lamp. As a result, the reflector can have a simpler shape, and furthermore the electrical connections between the power control unit and the lamp can be integrated in the fixation means.

In one preferred embodiment the power control unit is provided with a hole coaxial with the hole in the reflector, so that the cap of the lamp extends through at least a portion of said hole in the power control unit. The power control unit can thus be mounted to the reflector, for example by means of screws. The hole in the power control unit may be a blind hole, but preferably said hole is a through hole. In that case the bulb of the lamp can pass through the hole in the power control unit as well as the hole in the reflector before the cap of the lamp is fixed by the fixation means.

Preferably, the rear of the reflector comprises reference means for abutting against a portion of the cap of the lamp, in order to make sure that the lamp is placed in its predetermined position relative to the reflector. Said reference means may comprise a flat surface extending in radial direction with respect to the lamp, so that a portion of the cap of the lamp can abut against said flat surface.

In one preferred embodiment, said reference means comprise three protrusions for cooperation with corresponding recesses in the cap of the lamp. The lamp can be accurately positioned with respect to the reflector in all directions as a result of this.

Preferably, said power control unit is attached to the rear of the reflector and said fixation means comprise a clamping member for pushing a portion of the cap of the lamp against the rear of the reflector. The power control unit and/or the reflector may be provided with means for making sure that the lamp fits in the lamp assembly in only one position.

In one preferred embodiment, the power control unit is attached to the rear of the reflector after the lamp has been placed in said hole in the reflector, thus pushing a portion of the cap of the lamp against the rear of the reflector. The power control unit can be provided here with elastic pushing means for pushing the cap of the lamp against said surface at the rear side of the reflector, such that the power control unit is attached to the rear of the reflector. It is also possible to attach the power control unit to the rear of the reflector in a resilient way, so that it pushes as a whole against the cap of the lamp, which cap abuts against the rear side of the reflector.

For example, the power control unit may be attached to the rear of the reflector by a hinging joint, in order to hinge between an open position in which the lamp can be placed in position, and a closed position in which the power control unit pushes the cap of the lamp against said surface at the rear side of the reflector. The power control unit can be kept in the closed position by a lock element attached to the rear side of the reflector in this manner.

In one preferred embodiment, the rear side of the reflector is provided with a holder for keeping the power control unit in its position, so that the power control unit is moved into the holder in a direction substantially perpendicular to the axis of the lamp. Moving the power control unit into said holder pushes the cap of the lamp against said surface at the rear side of the reflector.

In another preferred embodiment, the rear side of the reflector is provided with a ring-shaped wall coaxial with the lamp, the power control unit being attached to said ring-shaped wall. For example, the connection between said ring-shaped wall and the power control unit may be a bayonet connection or a screw connection, and the power control unit may be screwed on the ring-shaped wall like a lid on ajar.

In still another preferred embodiment of the invention, the cap of the lamp is fixed in the power control unit, preferably by means of a bayonet connection. The power control unit may then comprise means for ensuring that the lamp can only be fixed in an accurate predetermined position. Of course the power control unit must be attached to the rear of the reflector in an accurate predetermined position in order to ensure the correct position of the lamp in the reflector.

Preferably, the power control unit is provided with electrical contacts cooperating with contacts in the cap of the lamp, and said electric contacts may be incorporated in said fixation means. In that manner the electric power can be supplied directly from the power control unit to the lamp without outside wires, cables and/or other separate parts.

The invention furthermore relates to a method of fixing a HID lamp in a reflector, whereby the lamp is placed in a hole in the reflector and whereby a power control unit is located at the rear of the reflector, which method is characterized in that the power control unit keeps the lamp in a predetermined position.

The invention will now be explained by means of a description of four embodiments of a lamp assembly, in which reference is made to a drawing, in which:

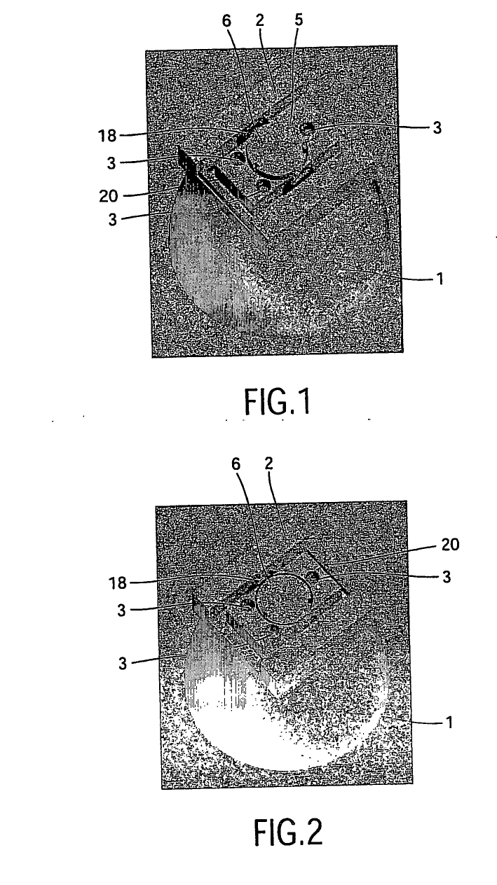

FIGS. 1 and 2 show a first embodiment of a lamp assembly;

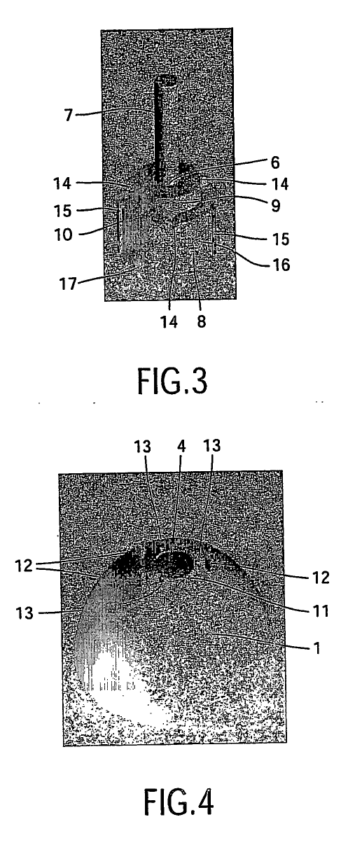

FIG. 3 shows a lamp;

FIG. 4 shows a reflector;

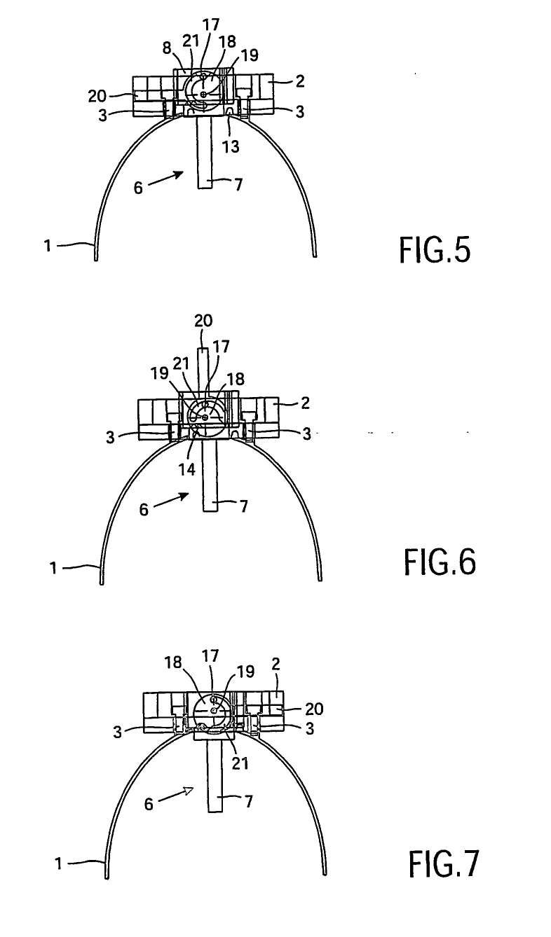

FIGS. 5, 6 and 7 show the fixation of the lamp in the first embodiment;

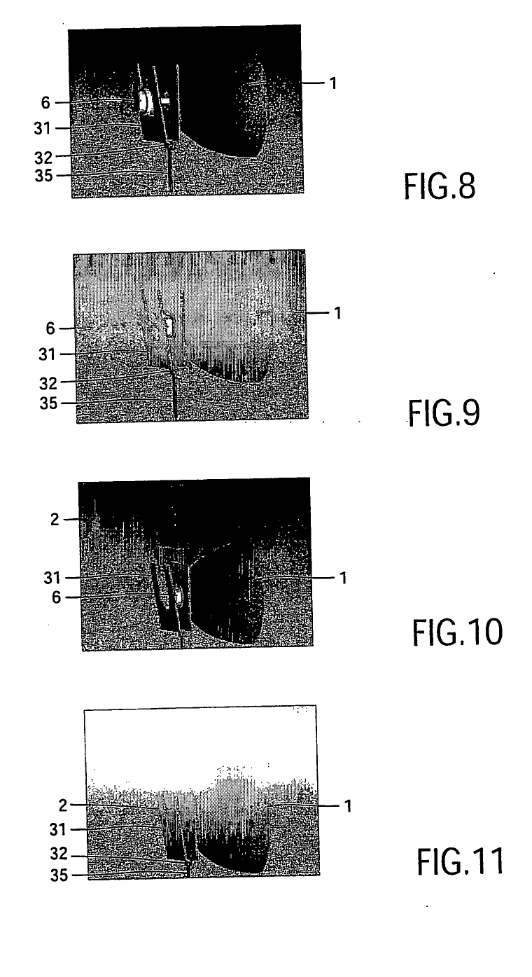

FIGS. 8, 9, 10 and 11 show a second embodiment of a lamp assembly;

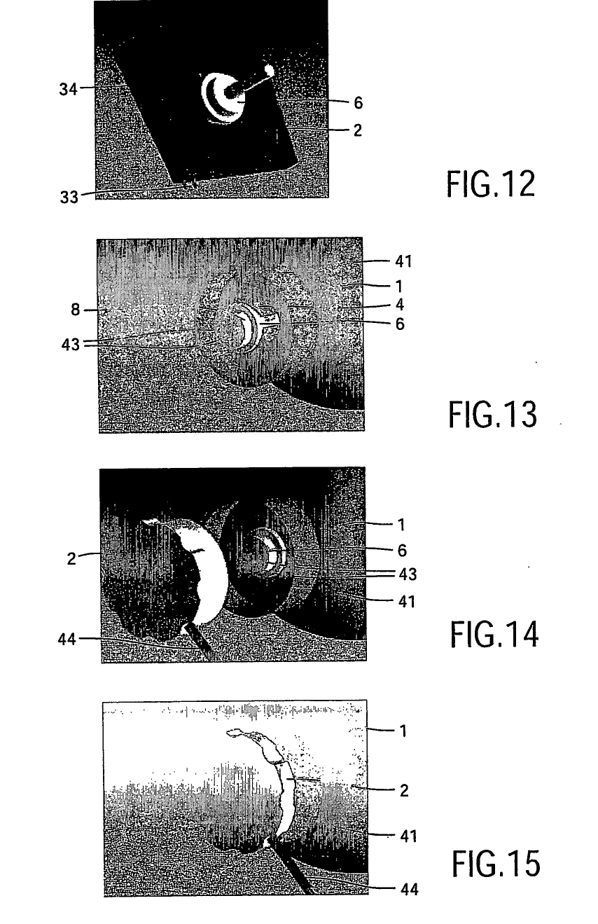

FIG. 12 shows the power control unit and the lamp of the second embodiment;

FIGS. 13, 14, 15 and 16 show a third embodiment of a lamp assembly;

FIGS. 17, 18, 19 and 20 show a fourth embodiment of a lamp assembly; and

FIG. 21 shows the lamp of the fourth embodiment.

The Figures are only schematic representations of the embodiments, similar parts in the different embodiments being indicated with the same reference numbers. FIG. 1 shows in perspective the rear of a reflector 1 to which a power control unit 2 is attached by means of three screws 3. The reflector 1 is provided with a hole 4 (see FIG. 4) and the power control unit 2 is also provided with a through hole 5. The two holes 4,5 are positioned coaxially, so that lamp 6 extends through both holes 4,5. FIGS. 1 and 2 show the cap 8 (see also FIG. 3) of lamp 6 being located in the hole 5 of the power control unit 2.

FIG. 3 is a schematic perspective view of the lamp 6 having a glass envelope 7 and a cap 8. In the lamp assembly, the envelope 7 is located inside the reflector 1 and the cap 8 is located in both the hole 4 of the reflector 1 and the hole 5 of the power control unit 2. Cylindrical portion 9 of cap 8 extends through hole 4 of the reflector 1 and a radially extending surface 10 of cap 8 abuts against a surface 11 (see FIG. 4) at the rear side of the reflector 1, which surface 11 surrounds hole 4.

FIG. 4 shows the rear side of the reflector 1 comprising the hole 4 and three cylindrical protrusions 12 having internal screw thread for cooperation with the screws 3 for attachment of the power control unit 2. The surface 11 at the rear side of the reflector 1 is provided with three small spherical protrusions 13. These protrusions 13 can engage with three recesses 14 in the radial surface 10 of cap 8. In fact, the contact between surface 11 of reflector 1 and surface 10 of cap 8 is limited to the spherical protrusions 13 and the recesses 14, ensuring an accurate predetermined positioning of envelope 7 of lamp 6 inside the reflector 1.

FIG. 3 shows two axial grooves 15 in the substantially cylindrical portion 16 of cap 8. These two grooves 15 cooperate with two corresponding ridges (not shown) in the substantially cylindrical wall of hole 5 in the power control unit 2. Therefore lamp 6 fits in only one position in hole 5, so that the lamp 6 is automatically mounted in a correct position. These grooves 15 and the corresponding ridges may be provided with electrical contacts to supply power from the power control unit 2 to lamp 6.

The substantially cylindrical portion 16 of cap 8 is furthermore provided with two radially extending pins 17, which pins 17 can be engaged by a clamping member 18 shown in FIGS. 1 and 2. FIG. 1 shows clamping member 18 in open position and FIG. 2 shows clamping member 18 in closed position, in which cap 8 of lamp 6 is pushed against the rear of reflector 1.

FIGS. 5, 6 and 7 show the functioning of clamping member 18 in more detail. These Figures show a cross-section of reflector 1 and a view of lamp 6, while power control unit 2 is represented partially transparent to show the functioning of clamping member 18.

Clamping member 18 is attached to power control unit 2 at both sides of the hole 5 by coaxial pins 19, so that clamping member 18 can hinge about said pins 19. To enable the hinging movement, clamping member 18 comprises a handle 20 (also shown in FIGS. 1 and 2). FIG. 5 shows the handle 20 in the open position of the clamping member 18 (directed to the left) and FIG. 7 shows the handle in the closed position of the clamping member 18 (directed to the right). FIG. 6 shows the position of the handle 20 when it is hinging from the open to the closed position—or reversed—of the clamping member 18.

Each of the two radially extending pins 17 of the cap 8 cooperates with a groove 21 of the clamping member 18, which grooves 21 extend in a spiral around coaxial pins 19. In the open position of the clamping member 18, as shown in FIG. 5, the lamp 6 can be inserted through hole 5 of the power control unit 2 and through hole 4 of the reflector 1, so that the two pins 17 will be located in the entrances of the two spiral grooves 21. Then a turning of the clamping member 18 around pins 19, by moving handle 20, will cause the pins 17 to be engaged by the grooves 21 and be moved further towards the reflector 1, as shown in FIG. 6. In the closed position of clamping member 18, as shown in FIG. 7, the recesses 14 of the cap 8 are pushed against the spherical protrusions 13 at the rear side of the reflector 1, so that the lamp 6 is clamped in its final predetermined position. The handle 20 can be locked in that position by known means.

FIGS. 8-12 show a second embodiment of a lamp assembly, in which the rear side of the reflector 1 is provided with a holder 31 for receiving and fixing the power control unit 2. The power control unit 2 can be moved into the holder 31 after the lamp 6 has been placed in the reflector 1. When the power control unit 2 is moved into its final position, it pushes the cap 8 of the lamp 6 against the rear side of the reflector 1 or against a wall portion of the holder 31. The rear side of the reflector 1, or the relevant wall portion, may be provided with three protrusions (like the protrusions 13 in FIG. 4) to cooperate with corresponding recesses in cap 8, in order to keep the lamp 6 in the predetermined position with respect to the reflector 1. It is also possible for the cap 8 to be provided with three protrusions abutting a surface at the rear side of the reflector 1 or a wall portion of holder 31.

FIG. 8 shows the reflector 1, and attached to it the holder 31. Holder 31 comprises an electrical connector 32 for cooperation with a connector 33 (FIG. 12) of the power control unit 2. Electrical power is supplied to connector 32 by cable 35.

FIG. 8 shows the situation where lamp 6 is moved into the mutually corresponding holes in the power control unit 2 and the holder 31. FIG. 9 shows the situation where lamp 6 has reached its final position in the lamp assembly, in which a radially extending portion of cap 8 of the lamp 6 abuts against the rear of the reflector or against a portion of the wall of holder 31, as the case may be.

Subsequently, as shown in FIG. 10, the power control unit 2 is moved towards and into the holder 31. Since the power control unit 2 is wedge-shaped, it can be easily moved into holder 31, such that cap 8 of lamp 6 is pushed in the direction of the reflector 1 and clamped in its predetermined position. FIG. 11 shows the lamp assembly when power control unit 2 has reached its final position and the electrical connector 32 is in engagement with connector 33 of the power control unit 2.

FIG. 12 shows the power control unit 2 and the lamp 6. The power control unit 2 comprises an electrical connector 33 for cooperation with the corresponding connector 32 of holder 31 and an electrical connector 34 for cooperation with a corresponding connector of cap 8 of lamp 6. The contacts of electrical connector 34 can be positioned such that electrical breakdown, caused by of a high starting voltage is prevented.

Both connectors 33, 34 will be engaged automatically with the cooperating connectors when the power control unit 2 is moved into holder 31.

FIGS. 13-16 show a third embodiment of a lamp assembly which in the rear side of the reflector 1 is provided with a ring-shaped wall 41 around the hole 4. The substantially disc-shaped power control unit 2 can be fixed to said wall 41, for example by a bayonet connection or by a screw connection, like a cover is attached to a holder. The power control unit 2 is attached to the wall 41 after the lamp 6 has been placed in the reflector 1. When the power control unit 2 is put in its final position, it pushes cap 8 of the lamp 6 against the rear of the reflector 1. The rear side of the reflector 1 may be provided with three protrusions (like the protrusions 13 in FIG. 4) in order to keep the lamp 6 in the predetermined position with respect to the reflector 1.

FIG. 13 shows the reflector 1 with the ring-shaped wall 41 at its rear side, a lamp 6 being moved into hole 4 in the reflector 1. FIG. 14 shows the situation in which lamp 6 is located in its final position in the lamp assembly, such that a radially extending portion of cap 8 of the lamp 6 abuts against the rear side of the reflector 1.

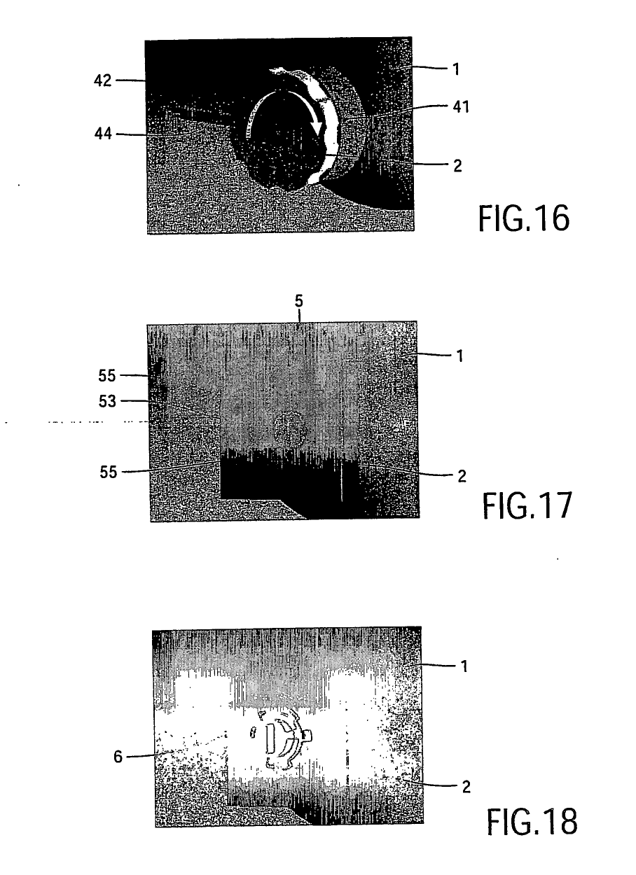

As shown in FIG. 15, the power control unit 2 is moved towards and into the ring-shaped wall 41, so that cap 8 of lamp 6 is pushed in the direction of the reflector 1 and clamped against the rear side of the reflector 1 in its predetermined position. FIG. 16 shows the lamp assembly with the power control unit 2 having reached its final position by rotating about its axis in the direction of arrow 42. Key means may be present to prevent the lamp from rotating when the power control unit 2 is rotated.

In the final position of power control unit 2, two electrical contacts 43 (see FIGS. 13 and 14) on the cap 8 of the lamp 6 abut against corresponding contacts in the power control unit 2, in order to supply power from the power control unit 2 to the lamp 6. An electrical cable 44 supplies power to power control unit 2.

FIGS. 17-21 show a fourth embodiment of a lamp assembly in which the power control unit 2 is attached to the rear side of the reflector 1 and the lamp 6 is fixed in the power control unit 2 by a bayonet connection.

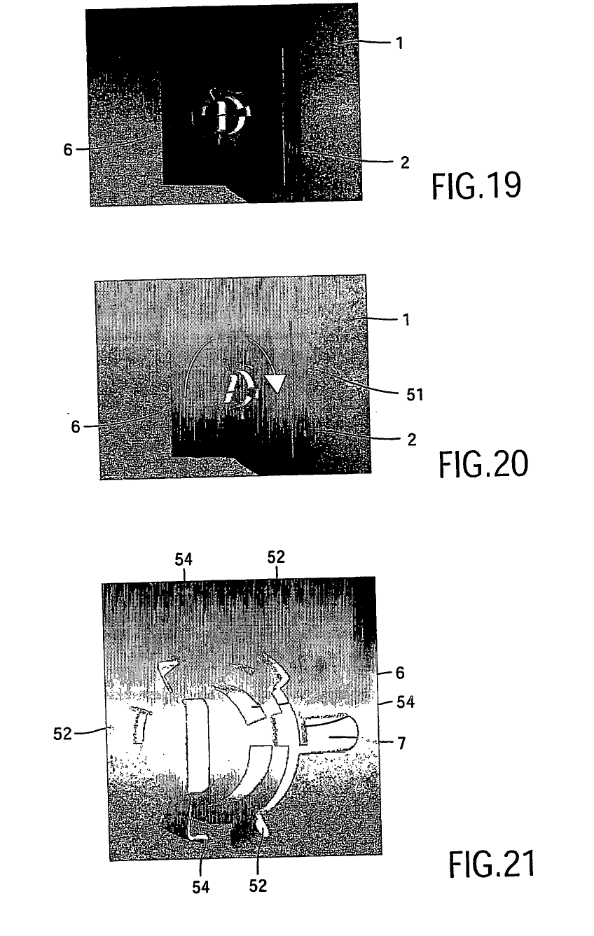

FIG. 17 shows the reflector 1 with the power control unit 2 attached to it. A through hole 5 of the power control unit 2 is positioned coaxially with the hole in the reflector 1, so that the lamp 6 can be moved through the hole 5 (FIGS. 18 and 19). Subsequently the lamp 6 can be turned to be fixed in its final predetermined position (FIG. 20), as indicated by arrow 51. After the cap 8 has been fixed, for example by a bayonet system, a portion of the cap 8 is pushed against the rear of reflector 1 by an axial force exerted by the power control unit 2.

FIG. 21 shows the lamp 6 in more detail. To provide an accurate and predetermined positioning of lamp 6 in power control unit 2, the bayonet connection comprises three radial protrusions 52 for engagement with corresponding recesses 53 (see FIG. 17) in hole 5 of power control unit 2. The three protrusions 52 are not evenly distributed around the cap 8, so that the lamp 6 fits in only one position in hole 5.

FIG. 21 also shows three electrical contacts 54 for cooperation with corresponding electrical contacts 55 (see FIG. 17) in hole 5 of power control unit 2. In most cases two contacts 54,55 are sufficient, but a third contact may be required for an additional function.

The four embodiments of the lamp assembly described above are merely examples; a great many other embodiments are possible.

1. An HID lamp assembly comprising a reflector (1), a discharge lamp (6) and a power control unit (2), wherein the cap (8) of the lamp (6) extends through a hole (4) in the reflector (1) and wherein the power control unit (2) is attached to the rear of the reflector (1) near said hole (4), characterized in that the power control unit (2) is provided with fixation means for keeping the lamp (6) in a predetermined position.

2. A lamp assembly as claimed in claim 1, characterized in that the power control unit (2) is provided with a hole (5) coaxial with the hole (4) in the reflector (1), and in that the cap (8) of the lamp (6) extends through at least a portion of said hole (5) in the power control unit (2).

3. A lamp assembly as claimed in claim 1, characterized in that the rear of the reflector (1) comprises reference means (11) for abutting against a portion (10) of the cap (8) of the lamp (6).

4. A lamp assembly as claimed in claim 3, characterized in that said reference means (11) comprise a flat surface extending in radial direction with respect to the lamp (6).

5. A lamp assembly as claimed in claim 3, characterized in that said reference means comprise three protrusions (13) for cooperation with corresponding recesses (14) in the cap (8) of the lamp (6).

6. A lamp assembly as claimed in claim 1, characterized in that said power control unit (2) is attached to the rear of the reflector (1) and said fixation means comprise a clamping member (18) for pushing a portion of the cap (8) of the lamp (6) against the rear of the reflector (1).

7. A lamp assembly as claimed in claim 1, characterized in that the power control unit (2) is attached to the rear of the reflector (1) after the lamp (6) has been placed in said hole (4) in the reflector (1), thereby pushing a portion of the cap (8) of the lamp (6) against the rear of the reflector (1).

8. A lamp assembly as claimed in claim 7, characterized in that the rear side of the reflector (1) is provided with a holder (31) for keeping the power control unit (2) in its position, such that the power control unit (2) is moved into the holder (31) in a direction substantially perpendicular to the axis of the lamp (6).

9. A lamp assembly as claimed in claim 7, characterized in that the rear side of the reflector (1) is provided with a ring-shaped wall (41) coaxial with the lamp (6), the power control unit (2) being attached to said wall (41).

10. A lamp assembly as claimed in claim 1, characterized in that the cap (8) of the lamp (6) is fixed in the power control unit (2).

11. A lamp assembly as claimed in claim 10, characterized in that the cap (8) of the lamp (6) is fixed in the power control unit (2) by means of a bayonet connection.

12. A lamp assembly as claimed in claim 1, characterized in that the power control unit (2) is provided with electric contacts cooperating with contacts in the cap of the lamp.

13. A lamp assembly as claimed in claim 12, characterized in that said electric contacts are incorporated in said fixation means.

14. A method of fixing an HID lamp in a reflector, whereby the lamp is placed in a hole in the reflector and whereby a power control unit is located at the rear of the reflector, characterized in that the power control unit keeps the lamp in a predetermined position.
